(19) United States
(12) Patent Application Publication
(10) Pub. No.: US 2017/0348895 A1
(43) Pub. Date: Dec. 7, 2017

(54) LOAD CARRIER AND METHOD FOR MANUFACTURING THE SAME

(71) Applicant: Fibreuse NV, Antwerpen (BE)

(72) Inventors: Sylvain Naets, Antwerpen (BE); Rudy Galle, Zingem (BE); Jesse Sels, Aartselaar (BE)

(73) Assignee: Fibreuse NV, Antwerpen (BE)

(21) Appl. No.: 15/537,322

(22) PCT Filed: Dec. 9, 2015
(86) PCT No.: PCT/EP2015/079120

§ 371 Date: Jun. 16, 2017

(30) Foreign Application Priority Data
Dec. 19, 2014 (EP) 14199158.8

(51) Int. Cl. B29C 51/00; B65D 19/38; B29C 70/06; B29K 311/00; B29K 309/08; B29L 31/00

(52) U.S. Cl. CPC B29C 51/004; B65D 19/38; B29C 70/06; B29K 2309/08; B29L 2031/7178; B29K 2311/00

(57) ABSTRACT

A load carrier is at least partially made of a nonwoven composite material board. The nonwoven composite material board comprising:
includes unraveled natural fibers and/or glass fibers, and
plastic fibers.

Also disclosed is a process for manufacturing a load carrier. The process includes mixing unraveled natural fibers and/or glass fibers, and plastic fibers, and thermoforming the mix into a nonwoven composite material layer. The disclosed load carriers may be any type of load carriers, such as boxes, top decks, cases, crates, and the like, and in particular, pallets.

### FIELD OF THE INVENTION

The present invention relates to a load carrier at least partially made of a nonwoven composite material board.

In addition, the present invention relates to a process for manufacturing a load carrier at least partially made of a nonwoven composite material board.

### BACKGROUND

In the context of the present invention, a pallet is a flat transport structure that supports goods in a stable fashion while being lifted by a forklift, pallet jack, front loader, work saver or other jacking device. A pallet is the structural foundation of a unit load which allows handling and storage efficiencies.

Conventional pallets are wooden, but can also be made of plastic, metal, paper, and recycled materials, depending on the field of use.

In particular in the use of recycled materials for pallets, many attempts are being made aiming to lower environmental impact. For example TW201113197 relates to a method for manufacturing an environmentally friendly pallet wherein agriculture waste or waste woods are fiberized and blended with waste paper slurry and crunched waste plastic. Subsequently, this blend is injection molded into a pallet.

However, it is commonly known that injection molding is a rather expensive technique for producing relatively simple designs at relatively low volumes.

Another example is BE901742 wherein industrial waste material, is used to produce single-use non-returnable transport pallets, crates, etc. the waste materials combined are waste plastics and files production items, waste cardboard from damaged or used boxes, bobbins, and waste wood from templates, reject pallets, or garden prunings and cellulose fibers are shredded and mixed. Then a dry adhesive bonding compound is added, the mixture heated and fed to a press to produce the pallets.

However, a clear drawback is the fact that the pallets are only intended for single use and do not have the characteristics required for several use cycles as for example in a pallet a pooling system.

Other examples of creating a pallet or load bearing device are WO2014058665, WO2004011337 describing a construction of a foam and/or cellular core surrounded by top and bottom skin layers. Further, US2005040307 describes a load carrier made by molding plastics (extrustion, injection moulding, . . . ) and whereby the strength of the final structure comes from a ribbed structure of the material. The pallets or load carriers described all require complex processing and/or complex structureal built-up in order to obtain required mechanical properties.

It is therefore an object of the present invention to provide a load carrier, in particular a pallet, having the characteristics required for being used in multiple use cycles, e.g. in a pallet pooling system, and in heavy duty applications, and which has a simple structural build-up without complex processing steps. Impact strength, swell, heat resistance, heat retardancy, dimensional stability, water absorbance, or racking capability may be at least comparable with or improved versus conventional pallets.

In another object of the present invention a load carrier is provided having impact strength and load characteristics comparable with the characteristics of conventional wooden pallets, such combined with significantly lower weight, resulting in significantly decreasing transport costs.

Another object of the present invention is to provide a load carrier made of recyclable and/or recycled materials.

Further, it is an object of the present invention to provide an improved method for manufacturing load carriers allowing using recycled and recyclable materials.

Further, the present invention provides a process allowing using porous, hydroscopic, visco-elastic raw materials as a base material in the manufacturing of durable, re-usable, and dimensionally stable load carriers.

A further general object of the present invention is to allow manufacturing of load carriers of different quality levels and end use, tailored for one way use as well as multiple use, for light duty applications as well as heavy duty.

### SUMMARY OF THE INVENTION

The present invention is directed to a load carrier at least partially made of a nonwoven composite material board comprising:
unravelled natural fibers and/or glass fibers, and
Plastic fibers.

In addition, the present invention is directed to a process for manufacturing a load carrier comprising mixing unravelled natural fibers and/or glass fibers, and plastic fibers, and thermoforming said mix into a nonwoven composite material layer.

It should be clear that the present invention is applied to any type of load carriers, such as boxes, cases, crates, top decks, and the like, and in particular pallets.

### DETAILED DESCRIPTION

In an embodiment in accordance with the present invention, a load carrier at least partially made of a nonwoven composite material board is provided, said nonwoven composite material board comprising:
unravelled natural fibers and/or glass fibers, and
Plastic fibers.

In the context of the present invention, the raw natural materials such as jute, hemp, cocos, etc are treated by a bast fibre opening machine or tearing machine to be unravelled to fiber stage. Unravelled natural fibers are also called bast fibers and may be up to several centimeters long. The unravelled natural fibers may comprise any natural fiber as for example jute, flax, hemp, sisal, coco, or bamboo, or animal fibers. Alternatively, or in combination with unravelled natural fibers also glass fibers may be used.

The most important types of natural fibres used in load carriers according to the present invention are flax, hemp, jute, kenaf, cocos and sisal due to their properties and availability. Using jute fiber has many advantages. Firstly it has wood like characteristics as it is a bast fibre. Jute has high specific properties, low density, less abrasive behaviour to the processing equipment, good dimensional stability and harmlessness. The fiber has a high aspect ratio, high strength to weight ratio, and has good insulation properties. Jute is a low cost eco-friendly product and is abundantly available, easy to transport.

In the context of the present invention, the plastic fibers may be freshly produced fibers or may originate from any type of waste or recycled plastic fiber sheet material, such as textile, fabric, carpet, clothing, or big bags (i.e. flexible intermediate bulk containers (FIBC)). In case of recycled plastic fibers, they may be obtained by unraveling or tearing, and optionally subsequently combing, recycled plastic fiber material, woven and non-woven. The plastic fiber material may be of any type of plastic used in the production of plastic fiber materials, woven or nonwoven, as for example polypropylene fibers, polyvinyl fibers, polyethylene fibers, polyester fibers, etc.

A load carrier in accordance with the present invention comprises a core of entangled unravelled natural fibers and/or glass fibers embedded in a plastic matrix having strength and rigidity present without the need for additional reinforcing material or structure to create the envisaged mechanical properties. The improved mechanical properties result from the mechanical entanglement of the used raw materials and the plastic fibers through nonwoven entanglement and thermoforming the entangled structure.

In an embodiment in accordance with the present invention, a load carrier is provided comprising at least 40% weight at least 50% weight, or at least 60% weight, or at least 80% weight, or at least 90% weight of unravelled natural fibers and/or glass fibers.

In another embodiment in accordance with the present invention, a load carrier is provided comprising less than 60% weight, or less than 50% weight, or less than 40% weight, or less than 20% weight or less than 10% weight, or less than 5% of plastic fibers.

Without being bound by any theory, it is believed that using unravelled fibers as described above results in nonwoven composite material having a 3-dimensional netting structure embedded in a plastic matrix, providing a load carrier in accordance with the present invention the characteristics required for being used in multiple use cycles, e.g. in a pallet pooling system. For example impact strength, racking capability, swelling (i.e. water absorbance) and heat resistance during wash cycles are important characteristics.

Further, impact strength and load characteristics may be comparable with the characteristics of conventional wooden pallets, such combined with significantly lower weight, resulting in significantly decreasing transport costs. For example, a typical wooden pallet weighing 20-25 kg may be replaced by a pallet weighing less than 15 kg, or even less than 12 kg.

Another benefit is that these load carriers are made of recyclable and/or recycled materials.

A load carrier in accordance with the present invention may further comprise a thermoharder. Such thermoharder may be any type of thermoharder material allowing mixing with a blend of unravelled natural fibers and/or glass fibers, and plastic fibers. Such thermoharder may be in powder form or in liquid form, for example a polyester-based powder, or an epoxy-based powder or liquid, or a formaldehyde-based powder or liquid, or polyurethane liquid resin, or a water glass based binder as described in WO2013079635 herewith incorporated by reference, or a biological binding agent including natural and/or synthetic biological substances, conjugates thereof, or derivatives including polymers thereof. An example may be a polysaccharide based binding agent.

Using a thermoharder may result in strengthening the plastic fiber matrix and may enhance the formation of even more durable and rigid nonwoven composite material board structure.

A load carrier in accordance with the present invention may comprise less than 50% weight or, less than 25% weight, or less than 20% weight or less than 10% weight, or less than 5% of said thermoharder.

In a particular embodiment of the present invention, a load carrier may comprise between 40 and 90% weight unravelled natural fibers and/or glass fibers, between 40 and 5% weight plastic fibers, and between 40 and 5% weight thermoharder.

In another particular embodiment of the present invention, a load carrier may comprise between 50 and 75% weight unravelled natural fibers and/or glass fibers, between 10 and 40% weight plastic fibers and between 10 and 40% weight thermoharder.

In another particular embodiment of the present invention, a load carrier may comprise between 50% and 75% weight unravelled natural fibers and/or glass fibers, 15 and 40% weight plastic fibers, and between 10 and 30% weight thermoharder.

In addition, a load carrier of the present invention may further comprise bi-component fibers, preferably less than 25% weight, or less than 20% weight or less than 10% weight, or less than 5% weight.

Bi-component fibers are manufactured from two different polymers by spinning and joining them in a simultaneous process from one spinneret, resulting for example in a fiber having a polyethyleneterefthalate core and a polypropylene outer layer.

In the context of the present invention, the bi-component fibers may be made of two components having a melting point of at least 80° C., or at least 110° C. for the outer layer, and at least 140° C. or at least 170° C. for the core.

Without being bound by any theory, it is believed that because of the fact that the core fiber due it's high melting point is kept intact during processing and is mixed with the unraveled natural fibers and/or glass fibers, whereas the outer layer becomes part of the plastic matrix, an even more strong and rigid structure may be obtained.

In addition, a load carrier according to the present invention may be at least partially made of nonwoven composite material board, said nonwoven composite material board made of a mono-layer of thermoformed and pressed nonwoven composite material, or made of a multilayer of thermoformed nonwoven composite material layers pressed onto each other.

Alternatively, within a multilayer of nonwoven composite material layers several monolayers may be alternated with layers of alternative materials.

A load carrier according to the present invention may be at least partially made of nonwoven composite material board having at one or more sides an outer layer treated for painting or other finishing steps.

Further, a load carrier according to the present invention may be at least partially made of nonwoven composite material board having at one or more sides one or more finishing layers, such as for example coating layers.

Further, the present invention provided a process for manufacturing a load carrier comprising mixing unravelled natural fibers and/or glass fibers, and plastic fibers, and thermoforming said mix into a nonwoven composite material layer.

In the context of the present invention, thermoforming may be any type of thermoforming suitable for composite board formation (e.g. thermobonding, heat pressing, moulding, vacuum molding, etc), and may comprise any type of heating having the capacity to sufficiently raise the temperature within the core of the composite material mix during thermoforming, such as for example steam heating or steam injection heating or microwave heating or air heating (i.e. blowing hot air over and/or through the material).

The temperature within the core of the composite material mix during thermoforming may be at least 100° C., or at least 120° C., or even at least 140° C.

A process according to the present invention may comprises mixing between 40 and 90% weight unravelled natural fibers and/or glass fibers, and between 10 and 60% weight plastic fibers.

Though natural fibers such as jute etc are porous, hydroscopic, visco-elastic materials, a process according to the present invention enables its use as a base material in the manufacturing of durable and re-usable load carriers.

The plastic fibers may have a melting point of at least 100° C., or at least 120° C., or even at least 140° C., such that during thermoforming the unravelled natural fibers (or the glass fibers) become sufficiently embedded within a plastic melt.

In a particular embodiment of the present invention, between 40 and 90% weight unravelled natural fibers and/or glass fibers, between 40 and 5% weight plastic fibers, and between 40 and 5% weight thermoharder may be mixed.

In another particular embodiment of the present invention, between 50 and 75% weight unravelled natural fibers and/or glass fibers, between 10 and 40% weight plastic fibers and between 10 and 40% weight thermoharder may be mixed.

The natural or glass fibers, and the plastic fibers may be blended by any conventional technique suitable for intermixing fibers, such as airlaying, needle punching, carding, wet-laying, spunlacing, or a combination thereof. For example, needle punching may be used, which is a technique wherein mechanical interlocking or entanglement of the fibers is achieved by means of thousands of barbed felting needles repeatedly passing into and out of the fiber mix.

The unravelled natural fibers and/or glass fibers and/or the plastic fibers may not be shredded, cut, milled of treated by any other technique with the purpose of decreasing the fibre length as compared to the unravelled natural fiber length or the original plastic fiber length.

The unravelled natural fiber length or glass fiber length may be at least 0.5 cm, or at least 0.7 cm, of which at least 50% is at least 1 cm, or a least 2 cm, in order to obtain a desired 3-dimensional netting structure. Preferably the fiber length is at least 1.2 cm, or preferably at least 1.5 cm, or even more preferably at least 4 cm.

The thermoharder may be mixed with the unravelled natural fibers and/or glass fibers, and the plastic fibers, by any type of conventional technique for mixing a powder into a blend of fibers, for example by means of airblowing or spreading onto the fiber layer. Alternatively in case of a liquid thermoharder, spraying or immersing may be used, for example a needle-punched material layer may be immersed in a bath of liquid thermoharder.

Subsequently to thermoforming the nonwoven composite material layer may be cold pressed, thereby forming a mono-layer nonwoven composite material board. Cold pressing may have the advantage of relaxing the nonwoven composite material board in order to decrease breaking risk. Alternatively, also heat pressing, or vacuum forming may be used.

Another alternative is that the step of thermoforming may comprise immediate heat pressing or vacuum forming the nonwoven composite material layer into a mono-layer nonwoven composite material board.

In an embodiment of the present invention, a process for manufacturing a load carrier may further comprise mixing bi-component fibers within the fiber mix.

In a preferred embodiment of the present invention, a process for manufacturing a load carrier is provided comprising thermoforming a plurality of nonwoven composite material layers and connecting them by pressing, vacuum forming, gluing, or welding, thereby forming a multilayer nonwoven composite material board.

Alternatively, within a multilayer of nonwoven composite material layers several monolayers may be alternated with layers of alternative materials.

A mono- or multilayer of composite material board may then further proceed to sawing or cutting into a plurality of elongated composite material boards for being connected into a load carrier structure.

The elongated composite materials boards may be glued or nailed to each other or onto block elements as for example used in block pallets.

A process for manufacturing a load carrier according to the present invention may further comprise a finishing treatment onto one or more sides of the nonwoven composite board material, for example coating, painting, waxing, etc.

Alternatively such process may further comprise providing one or more finishing layers and pressing said one or more finishing layers onto one or more sides of the nonwoven composite board material. Such finishing layer may be for example a coating layer.

In an embodiment of the present invention, a particular process for manufacturing a load carrier is provided comprising:
mixing unravelled natural fibers and/or glass fibers, plastic fibers, and thermoharder powder
Pre-heating the mix in pre-heating mould
transporting to pre-heated fiber layer into a steam injection oven, thereby forming a nonwoven composite material layer
cold pressing the nonwoven composite material layer
pressing several nonwoven composite material layers onto each other thereby forming a multilayer nonwoven composite board
sawing/cutting the multilayer nonwoven composite board into elongated boards
nailing the elongated boards onto block elements.

In another embodiment of the present invention, an alternative process for manufacturing a load carrier is provided comprising:
mixing unravelled natural fibers and/or glass fibers, and plastic fibers by airlaying, needle punching, carding, wet-laying, spunlacing, or a combination thereof, resulting in a provisional non-woven composite fiber mat.
sprinkling thermoharder liquid onto this composite fiber mat, or immersing the mat into a thermoharder liquid bath
heat pressing the immersed mat into a nonwoven composite material layer
pressing several nonwoven composite material layers onto each other thereby forming a multilayer nonwoven composite board
sawing/cutting the multilayer nonwoven composite board into elongated boards
nailing the elongated boards onto block elements.

The present invention allows manufacturing of load carriers of different quality levels and end use, tailored for one way use as well as multiple use, for light duty applications as well as heavy duty. The difference in quality (and price) level will come from differences in mixtures of raw materials, differences in processing steps and/or differences in thickness of the composite material board used to create the load carriers.

1. A load carrier at least partially made of a nonwoven composite material board, said a nonwoven composite material board comprising:
at least one of unraveled natural fibers and glass fibers; and
plastic fibers.

2. The load carrier according to claim 1, comprising at least 40% weight at least 50% weight, or at least 60% weight, or at least 80% weight, or at least 90% weight of unraveled natural fibers and/or glass fibers.

3. The load carrier according to claim 1, comprising less than 60% weight, or less than 50% weight, or less than 40% weight, or less than 20% weight or less than 10% weight, or less than 5% of plastic fibers.

4. The load carrier according to claim 1, further comprising a thermoharder.

5. The load carrier according to claim 4, comprising less than 50% weight or, less than 25% weight, or less than 20% weight or less than 10% weight, or less than 5% of thermoharder.

6. The load carrier according to claim 5, comprising between 50 and 75% weight unraveled natural fibers and/or glass fibers, between 10 and 40% weight plastic fibers and between 10 and 40% weight thermoharder.

7. The load carrier according to claim 1, wherein the a nonwoven composite material board further comprises bi-component fibers.

8. A process for manufacturing a load carrier comprising mixing unraveled natural fibers and/or glass fibers, and plastic fibers, and thermoforming said mix into a nonwoven composite material layer.

9. The process for manufacturing a load carrier according to claim 8, wherein thermoforming comprises steam heating or steam injection heating or microwave heating or air heating.

10. The process for manufacturing a load carrier according to claim 8, wherein between 40 and 90% weight unraveled natural fibers and/or glass fibers, between 10 and 60% weight plastic fibers are mixed.

11. The process for manufacturing a load carrier according to claim 8, wherein between 40 and 90% weight unraveled natural fibers and/or glass fibers, between 40 and 5% weight plastic fibers, and between 40 and 5% weight thermoharder are mixed.

12. The process for manufacturing a load carrier according to claim 8, wherein the step of mixing is comprises airlaying, needle punching, carding, wet-laying, spunlacing, or a combination thereof.

13. The process for manufacturing a load carrier according to claim 8, wherein the step of mixing comprises needle punching or spunlacing, or a combination thereof.

14. The process for manufacturing a load carrier according to claim 8, wherein subsequently to thermoforming the nonwoven composite material layer is cold pressed, heat pressed, or vacuum formed, thereby forming a mono- or multilayer nonwoven composite material board.

15. The process for manufacturing a load carrier according to claim 8, comprising thermoforming a plurality of nonwoven composite material layers and connecting them by pressing, vacuum forming, gluing or welding, thereby forming a multilayer nonwoven composite material board.
